(19) United States
(12) Patent Application Publication
(10) Pub. No.: US 2018/0320618 A1
(43) Pub. Date: Nov. 8, 2018

(54) INTERNAL COMBUSTION ENGINE WITH INJECTION AMOUNT CONTROL

(71) Applicant: GE Jenbacher GmbH & Co. OG, Jenbach (AT)

(72) Inventors: Raphael BURGMAIR, Feldkirchen-Westerham (DE); Dino IMHOF, Baden (CH); Medy SATRIA, München (DE)

(21) Appl. No.: 15/773,576

(22) PCT Filed: Nov. 3, 2016
(86) PCT No.: PCT/EP2016/076616

§ 371 Date: May 4, 2018

(30) Foreign Application Priority Data
Nov. 4, 2015 (EP) 15192918.9

(51) Int. Cl. F02D 41/14; F02D 41/20; F02D 41/40; F02D 29/00

(52) U.S. Cl. CPC F02D 41/1402; F02D 41/20; F02D 41/40; F02D 2041/286; F02D 2041/1416; F02D 2041/143; F02D 2041/1434; F02D 29/00

(57) ABSTRACT

A combustion engine with at least one injector for the injection of liquid fuel into at least one combustion chamber is provided. The injector can be regulated by means of a regulating device through an actuator triggering signal, wherein the at least one injector has an outlet opening that can be closed by means of a needle. An algorithm is contained in the regulating device, which receives as an input value at least the actuator trigger signal, and which calculates via an injector model the mass of liquid fuel transferred via the outlet opening of the injector. The regulating device compares by means of the injector model, the calculated mass with a required target value ref of the mass of liquid fuel, to correct the actuator trigger signal.

### TECHNOLOGY FIELD

Embodiments of the present disclosure concern a combustion engine having the characteristics of the generic concept in claim 1, and a process with the characteristics of the generic concept in claim 12 or 13.

### BACKGROUND

A combustion engine typical of its class and a process typical of its class are represented in DE 100 55 192 A1. This specification discloses a process for the smooth concentric running of diesel engines, in which the injection quantity from the injectors allocated to the cylinders is corrected by means of a correction factor.

In the present state of the art, there is a problem in that, in order to provide compensation for aging and wear phenomena of the injector (injector drift), the combustion engine cannot be operated within the actually-allowed limits for pollution emissions, but only after applying a deterioration factor, which leaves a greater divergence from the permitted limit.

Over the lifetime [of the injector], the actually injected mass of liquid fuel which is available for a particular actuator triggering signal (e.g. duration of current supply) changes due to injector drift.

### SUMMARY OF THE DISCLOSURE

The object of embodiments of the disclosure is to provide a combustion engine and a process by means of which it is possible throughout the lifetime of an injector to operate the combustion engine more closely to the pollutant emission limits.

This object is achieved by a combustion engine with the characteristics of claim 1 and a process with the characteristics of claim 12 or 13. Advantageous embodiments of the disclosure are defined in the dependent Claims.

Diesel may be mentioned as an example of the liquid fuel. It could also be heavy fuel oil or some other fuel capable of self-ignition.

Because an algorithm has been incorporated into the regulating system and which receives as input values at least the actuator trigger signal and calculates via the injector model the mass of liquid fuel (i.e. diesel) issued from the exit opening of the injector, and compares the mass calculated by the injector model with the required target value of the mass of liquid fuel, and depending on the result of the comparison, leaves unchanged or corrects the actuator control signal, it is possible to regulate precisely the mass of liquid fuel throughout the whole of the lifetime of the injector. This means that it is always possible to work at the limit allowed for pollution emissions.

On the basis of the actuator trigger signal, the algorithm estimates a mass of injected liquid fuel. Embodiments of the disclosure then take the mass of injected fuel calculated by the algorithm and compares this value with the required target value. In the event of deviations, correction can be made immediately (e.g. within 10 milliseconds).

Naturally, instead of the mass of injected fuel, the volume or other values could be calculated, which are characteristic for a particular mass of injected fuel. All these possibilities are covered by the use of the concept “mass” in this disclosure.

It is preferable that at least one sensor be provided, by means of which a measurement value from at least one injector can be measured, and for which purpose the sensor is in or can be brought into signal connection with the regulating device. In this case, the algorithm can calculate, via the injector model, the mass of liquid fuel emitted through the exit opening of the injector taking into account the at least one measured value. It is, of course, possible that several measurement values be used for assessing the injected mass of liquid fuel.

It is, in an embodiment, provided that the algorithm possess a preliminary control which calculates a preliminary control command (also referred to as a “Preliminary control signal”) for the actuator trigger signal controlling the injection duration, using as a basis the required target value for the mass of liquid fuel. The preliminary control for the actuator triggering signal ensures a rapid system response, since it activates the injector with a particular injection duration, as though no injector variability existed. The preliminary control value uses e.g. one field of injector characteristics (which, for example, indicates the duration of current supply for an actuator designed as a solenoid valve using the injection mass or volume) or an inverted injector model in order to convert the target value for the mass of liquid fuel to be injected, into the preliminary control command for the injection duration.

In one embodiment of a regulating device with a preliminary control system, it can, in an embodiment, be provided that the algorithm have a feedback loop (FB), which, taking into consideration the preliminary control command for the injection duration and the at least one measurement value, calculates the mass of liquid fuel issued through the exit opening of the injector and, if necessary, (if there is a deviation) corrects the target value for the injection duration calculated by the preliminary control. The feedback loop is used in order to correct any inaccuracies in the preliminary control value (due to manufacturing variabilities, wear, etc.), which cause injector drift.

It is preferable that the algorithm possess an observer function which, using the injector model, estimates the injected mass of liquid fuel depending on the at least one measurement value and the at least one actuator trigger signal. An actual measurement of the injected mass of liquid fuel is therefore not required for the feedback loop. Irrespective of whether a feedback loop is provided, the injected mass of liquid fuel estimated by the observer can be used in the preliminary control in order to improve the actuator triggering signal.

Experts can find in professional literature various possible designs for the observer (e.g. Luenberger Observer, Kalman-Filter, “Sliding Mode” observer, etc.).

With the help of the injector model, the observer may also serve to take into account the changing condition of the injector (e.g. through aging or wear) during its lifetime in order to improve the preliminary control signal and/or the actuator triggering signal.

In principle, it is possible to calculate the actuator triggering signal directly based on the target value for the injected mass of liquid fuel and based on the mass of liquid fuel estimated by the observer. In this way, an adaptive preliminary control signal is obtained that is modified by the observer. In this case, the control system is not designed in two parts, with both a preliminary control and a feedback loop to correct the preliminary control signal.

It can be provided that the injector model includes at least:

the progressions of the pressure in the volumes of the injector that are filled with liquid fuel;

the mass flow rates between the injector volumes filled with liquid fuel;

one position of the needle, in an embodiment, relative to the needle seat;

the dynamics of the needle actuator, in an embodiment, the dynamics of a solenoid valve.

The injector may possess as a minimum:

one input accumulator chamber connected with one Common-Rail of the combustion engine;

one accumulator chamber for liquid fuel that is connected to the input accumulator chamber;

one volume above the needle seat that is connected with the accumulator chamber;

one connection volume that is connected on the one side with the accumulator chamber and on the other side with an outflow duct;

one output opening for liquid fuel that can be closed by means of a needle, and which is connected with the volume above the needle seat;

one actuator, in an embodiment, a solenoid valve, that can be triggered by means of an actuator triggering signal, for opening the needle;

In an embodiment, one control chamber joined on the one side to the accumulator chamber and on the other side to the connection volume.

The needle is usually pretensioned by a spring in the direction opposite to the opening direction.

An injector may also be provided, which functions without a control chamber, e.g. an injector in which the needle is triggered by a Piezo element.

The at least one measurement value can be selected e.g. from the following values or from a combination of them:

pressure in one Common-Rail of the combustion engine;

pressure in one input accumulator chamber of the injector;

pressure in one control chamber of the injector;

commencement of the lift-off of the needle from the needle seat.

The regulating device can, in addition, be so designed that it implements the algorithm during each combustion cycle or during selected combustion cycles of the combustion engine, and in the event of deviations, that it corrects the actuator triggering signal and/or the preliminary control signal for the control element during that combustion cycle.

Alternatively, the regulating device can be so designed that it implements the algorithm during each combustion cycle or selected combustion cycles of the combustion engine, and in the event of deviations, corrects the actuator triggering signal in one of the subsequent combustion cycles, in an embodiment, the immediately subsequent combustion cycle.

Alternatively, or in addition to one of the above embodiments, the regulating device can be so designed as to implement the algorithm during each combustion cycle or during selected combustion cycles of the combustion engine, to evaluate statically any deviations that have occurred, and to carry out a correction for this or one of the subsequent combustion cycles depending on such static evaluation.

It is not absolutely necessary for embodiments of the disclosure that the mass of injected liquid fuel should be directly measured. It is also not necessary to derive the actually injected mass of liquid fuel from the at least one measurement value.

Embodiments of the disclosure may be employed in a stationary combustion engine, for marine applications or mobile applications, such as so-called “Non-Road-Mobile-Machinery” (NRMM)—in an embodiment, in each case in the form of a reciprocating piston engine. The combustion engine can serve as a mechanical drive, e.g. for operating compressor installations or in connection with a generator in a genset for production of electrical energy. The combustion engine, in an embodiment, possesses a number of combustion chambers with corresponding gas feed devices and injectors.

The control may occur individually for each combustion chamber.

### BRIEF DESCRIPTION OF THE DRAWINGS

Examples of embodiments of the disclosure are explained using figures, which show:

FIG. 1 a first embodiment of the regulating system diagram;

FIG. 2 a second embodiment of the regulating system diagram;

FIG. 3 a first example of a schematically represented injector; and

FIG. 4 a second example of a schematically represented injector.

### DETAILED DESCRIPTION

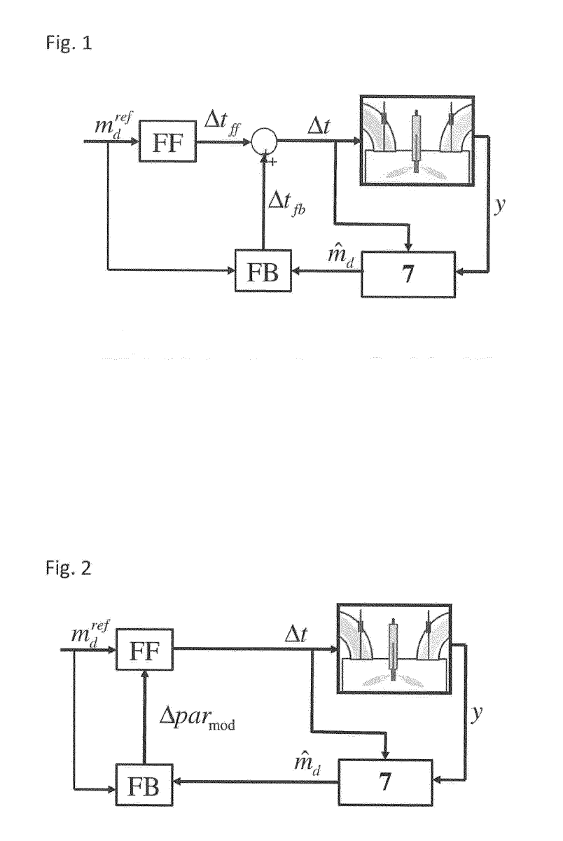

FIG. 1:

The purpose of the injector regulation in this embodiment is the regulation of the actually injected mass of liquid fuel to a target value m_{d}^{ref}, by controlling the injection duration Δt. The regulation strategy is carried out by:

a preliminary control (FF), which uses a required target value m_{d}^{ref} for the mass of liquid fuel to calculate a preliminary control signal Δt_{ff} (also referred to below as “control command”) for the injection duration Δₜ and

a feedback loop (FB), which by using an observer system 7 (“State Estimator”) takes into account the control command, calculated by the precontrol system, for the injection duration Δₜ and at least one measurement value y (e.g. one of the pressure progressions P_{IA}, P_{CC}, P_{JC}, P_{AC}, P_{SA}, occurring in the injector or the commencement of the lift-off of the needle from the needle seat) estimates, by means of the injector model, the mass flow \hat{m}_{d} of liquid fuel introduced through the output opening of the injector and, where required, corrects the target value Δt_{ff} calculated by the preliminary control for the injection duration by using a correction value Δt_{fb} (which may be negative).

The preliminary control ensures a fast system response, since it triggers the injector with an injection duration Δt_{ff} as though no injector variability existed. The preliminary control uses a calibrated field of injector characteristics (which determines the current supply duration via the injection mass or volume) or to convert the inverted injector model into the preliminary control command Δt_{ff} for the injection duration using the target value m_{d}^{ref} for the mass of liquid fuel.

The feedback loop (FB) is used in order to correct any inaccuracies in the preliminary control system (due to manufacturing variability, wear, etc.), which cause injector drift. The feedback loop compares the target value m_{d}^{ref} with the estimated injected mass \hat{m}_{d} of liquid fuel and gives as a feedback a correcting control command for the injection duration Δt_{fb} if there is any discrepancy between m_{d}^{ref} and \hat{m}_{d}. The addition of Δt_{ff} and Δt_{fb} or gives the definitive injection duration Δt.

The observer system estimates the injected mass \hat{m}_{d} of liquid fuel depending on the at least one measurement value y and the final injection duration Δt. The at least one measurement value y can, for example, refer to: common rail pressure P_{CR}, pressure in the input accumulation chamber P_{IA}, pressure in the control chamber P_{CC} or the commencement of the lift-off of the needle from the needle seat. The observer system uses a reduced injector model in order to estimate the injected mass \hat{m}_{d} of liquid fuel.

FIG. 2:

This figure shows a regulating system composed of a single part (without a preliminary control command Δt_{ff}) in which the actuator trigger signal Δₜ is calculated on the basis of the target value m_{d}^{ref} for the injected mass of liquid fuel and on the basis of the parameter Δpar_{mod} which is estimated by the observer function and used in the preliminary control model. In this way, an adaptive preliminary control signal is obtained that is modified by the observer.

Hence, in this case, the regulating system is not composed in two parts, with a preliminary control and a feedback loop that corrects the preliminary control signal.

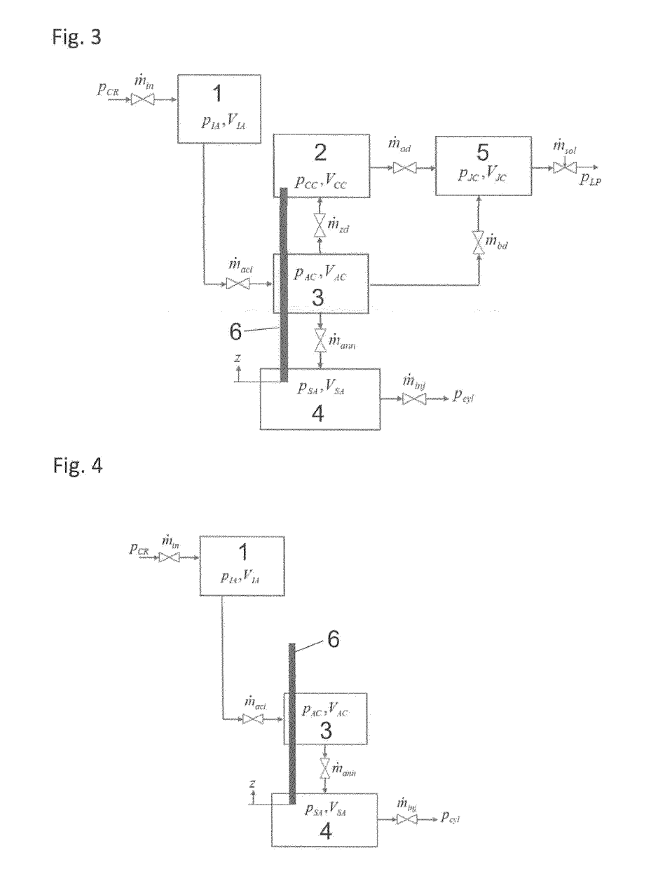

FIG. 3 shows a block diagram for a reduced injector model. The injector model consists of a structural model for the injector and a system of equations for describing the dynamic behavior of the structural model. The structural model consists of five modeled volumes: Intake accumulator 1, accumulator chamber 3, control chamber 2, volume above the needle seat and connection volume 5.

The intake accumulator chamber 1 represents the accumulation of all the volumes between the input choke and the non-return valve. The accumulator chamber 3 represents the combination of all volumes from the non-return valve to the volume above the needle seat. The volume above the needle seat represents a combination of all volumes between the needle seat up to the output opening of the injector. The connection volume 5 represents the combination of all the volumes, which connect the volumes of the accumulator chamber 3 and the control chamber 2 with the solenoid valve.

FIG. 4 shows an alternative injector design, which succeeds in functioning without a control chamber, e.g. an injector in which the needle is triggered by a Piezo element.

The following system of equations does not refer to the version shown in FIG. 4. The formulation of a suitable equation system can be carried out analogously to the equation system shown below.

The dynamic behavior of the structural model is described through the following equation system:

Pressure Dynamics

The development through time of the pressure within each of the volumes is calculated on the basis of a combination between the mass conservation equation and the pressure-density characteristic of the liquid fuel. The progression through time of the pressure is determined by:

$$\begin{matrix}{\dot{p}}_{IA} = \frac{{K}_{f}}{{ρ}_{IA} {V}_{IA}} ( {\dot{m}}_{i n} - {\dot{m}}_{aci} ) & EQ . 1.1 \\ {\dot{p}}_{CC} = \frac{{K}_{f}}{{ρ}_{CC} {V}_{CC}} ( {\dot{m}}_{zd } - {\dot{m}}_{ad} - {ρ}_{CC} {\dot{V}}_{CC} ) & EQ . 1.2 \\ {\dot{p}}_{jC} = \frac{{K}_{f}}{{ρ}_{JC} {V}_{JC}} ( {\dot{m}}_{bd} + {\dot{m}}_{ad} - {\dot{m}}_{sol} ) & EQ . 1.3 \\ {\dot{p}}_{A C} = \frac{{K}_{f}}{{ρ}_{A C} {V}_{A C }} ( {\dot{m}}_{aci} - {\dot{m}}_{ann} - {\dot{m}}_{bd} - {\dot{m}}_{zd} - {ρ}_{A C} {\dot{V}}_{A C} ) & EQ . 1.4 \\ {\dot{p}}_{SA} = \frac{{K}_{f}}{{ρ}_{SA} {V}_{SA}} ( {\dot{m}}_{ann} - {\dot{m}}_{inj} - {ρ}_{SA} {\dot{V}}_{SA} ) & EQ . 1.5\end{matrix}$$

Symbols used in the formulae
P_{IA}: Pressure in the intake accumulator chamber 1 in bar
P_{CC}: Pressure in the control chamber 2 in bar
P_{JC}: Pressure in the junction volume 5 in bar
P_{AC}: Pressure in the accumulator chamber 3 in bar
P_{SA}: Pressure in the small accumulator chamber 4 in bar
P_{IA}: Diesel mass density within the intake accumulator chamber 1 in kg/m³
P_{CC}: Diesel mass density within the control chamber 2 in kg/m/³
P_{JC}: Diesel mass density within the junction volume 5 in kg/m³
P_{AC}: Diesel mass density within the accumulation chamber 3 in kg/m³
P_{SA}: Diesel mass density within the small accumulator chamber 4 in kg/m³
K_{f}: Compression modulus of the Diesel fuel in bar

Needle Dynamics

The needle position is calculated by means of the following movement equation:

$$\begin{matrix}\ddot{z} = \{ \begin{matrix}0 if {F}_{hyd} \leq {F}_{pre} \\ \frac{1}{m} ( {F}_{hyd} - Kz - B \dot{z} - {F}_{pre} ) if {F}_{hyd} > {F}_{pre}\end{matrix} & EQ . 2.1 \\ {F}_{hyd} = {p}_{A C} {A}_{A C} + {p}_{SA} {A}_{SA} - {p}_{CC} {A}_{CC} & EQ . 2.2 \\ 0 \leq z \leq {z}_{ma x} & EQ . 2.3\end{matrix}$$

Symbols used in the formulae:
z: Needle position in meters (m)
zₘₐₓ: Maximum displacement of the needle 6 in m
k: Stiffness of spring in N/m
B: Spring damping co-efficient in N.s/m
Fₚᵣₑ: Spring pretension in N
A_{AC}: Hydraulic effective area in the accumulator chamber 3 in m²
A_{SA}: Hydraulic effective area in the small accumulator chamber 4 in m²
A_{CC}: Hydraulic effective area in the control chamber 2 in m²

Dynamics of the Solenoid Valve

The solenoid valve is modeled through a first order transfer function, which converts the valve opening command into a valve position. This is provided by:

$${}^{{u}_{sol}^{cmd}} \frac{{z}_{sol}^{m ax}}{{τ}_{sol} s + 1} {}^{{z}_{sol}}$$

The transient system behavior is characterized by the time constant tₛₒₗ and the position of the needle 6 at maximum valve opening is given by Z^{max}/ₛₒₗ 1. A piezo-electric operation is also possible instead of a solenoid valve.

Mass Flow Rates

The mass flow rate through each valve is calculated using the standard choked flow equation for liquids, which is:

$$\begin{matrix}{\dot{m}}_{i n} = {A}_{i n} {C}_{din} \sqrt{2 {ρ}_{j} \vert {p}_{Ck} - {p}_{iA} \vert} \cdot sgn ( {p}_{CR} - {p}_{iA} ) & EQ . 3.1 \\ {\dot{m}}_{bd} = {A}_{bd} {C}_{dbd} \sqrt{2 {ρ}_{j} \vert {p}_{A C} - {p}_{jC} \vert} \cdot sgn ( {p}_{A C} - {p}_{jC} ) & EQ . 3.2 \\ {\dot{m}}_{zd} = {A}_{zd} {C}_{dzd} \sqrt{2 {ρ}_{j} \vert {p}_{A C} - {p}_{CC} \vert} \cdot sgn ( {p}_{A C} - {p}_{CC} ) & EQ . 3.3 \\ {\dot{m}}_{ad} = {A}_{ad} {C}_{dad} \sqrt{2 {ρ}_{j} \vert {p}_{CC} - {p}_{jC} \vert} \cdot sgn ( {p}_{CC} - {p}_{jC} ) & EQ . 3.4 \\ {\dot{m}}_{sol} = {A}_{sol} {C}_{dsol} \sqrt{2 {ρ}_{j} \vert {p}_{jC} - {p}_{LP} \vert} \cdot sgn ( {p}_{jC} - {p}_{LP} ) & EQ . 3.5 \\ {\dot{m}}_{aci} = {A}_{aci} {C}_{deci} \sqrt{2 {ρ}_{j} \vert {p}_{iA} - {p}_{A C} \vert} \cdot sgn ( {p}_{iA} - {p}_{A C} ) & EQ . 3.6 \\ {\dot{m}}_{ann} = {A}_{ann} {C}_{dmn} \sqrt{2 {ρ}_{j} \vert {p}_{A C} - {p}_{SA} \vert} \cdot sgn ( {p}_{A C} - {p}_{SA} ) & EQ . 3.7 \\ {\dot{m}}_{inj} = {A}_{inj} {C}_{dinj} \sqrt{2 {ρ}_{SA} \vert {p}_{SA} - {p}_{cyl} \vert} \cdot sgn ( {p}_{SA} - {p}_{cyl} ) & EQ . 3.8 \\ {ρ}_{j} = \{ \begin{matrix}{ρ}_{i n} if {p}_{i n} \geq {p}_{out} \\ {ρ}_{out} if {p}_{i n} < {p}_{out}\end{matrix} & EQ . 3.9\end{matrix}$$

Formula symbols used:
\dot{m}ᵢₙ: Mass flow density through the input choke in kg/s
\dot{m}_{bd}: Mass flow rate via the bypass valve between accumulator chamber 3 and junction volume 5 in kg/s
\dot{m}_{zd}: Mass flow rate via feeder valve at the entry point of the control chamber 3 in kg/s
\dot{m}_{ad}: Mass flow rate via the discharge valve from control chamber 2 in kg/s
\dot{m}ₛₒₗ: Mass flow rate via the solenoid valve in kg/s
\dot{m}_{aci}: Mass flow rate via the entry point into the accumulator chamber 3 in kg/s
\dot{m}ₐₙₙ: Mass flow rate via the needle seat in kg/s
\dot{m}ᵢₙⱼ: Mass flow rate via the injector jet in kg/s

On the basis of the injector model formulated above, the expert will obtain the estimated value and by means of the observer system in a manner which is in principle already known (see e.g. B. Iserman, Rolf, “Digitale Regelsysteme” [“Digital control systems”], Springer Verlag Heidelberg 1977, Chapter 22.3.2, Page 379 et seq. or F. Castillo et al. “Simultaneous Air Fraction and Low-Pressure EGR Mass Flow Rate Estimation for Diesel Engines”, IFAC Joint conference SSSC—5th Symposium on System Structure and Control, Grenoble, France 2013).

By using the above system of equations, it is possible to construct the so-called “observer equations,” making use of an observer system which is known in principle, of the “sliding mode observer” type, by adding to the equations in the injector model the so-called “observer law.” For a “sliding mode” observer, one obtains the observer law by calculating a hypersurface using the at least one measurement signal and the value that results from the observer equations. By squaring the equation for the hypersurface, one obtains a generalized Lyapunov equation (generalised energy equation). This is a functional equation. The observer law represents that function which is minimized by the functional equation. This can be determined by variation techniques, which are known in principle, or numerically. This process is carried out within a combustion cycle for each step in time (depending on the time resolution of the control system).

Depending on the application, the result is the estimated injected mass of liquid fuel, the position of needle 6 or one of the pressures in one of the volumes of the injector.

This written description uses examples to disclose preferred embodiments, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A combustion engine comprising:
a regulating device,
at least one combustion chamber; and
at least one injector that can be regulated through a regulating device via an actuator trigger signal for injecting liquid fuel into the at least one combustion chamber, with the at least one injector possessing an exit opening for liquid fuel that can be closed by a needle;
wherein the regulating device incorporates an algorithm, receives as an input value at least the actuator trigger signal, using an injector model calculates the mass of the liquid fuel emitted from the exit opening of the injector, compares the mass calculated by the injector model with a required target value of the mass of the liquid fuel, and depending on the result of such comparison, leaves the actuator trigger signal unchanged or corrects the actuator trigger signal.

2. The combustion engine in accordance with claim 1, wherein the algorithm possesses a preliminary control which, on the basis of the required target value for the mass of the liquid fuel calculates a preliminary control signal for the actuator trigger signal for the injection duration.

3. The combustion engine in accordance with claim 1, wherein at least one sensor is provided in, or can be brought into, signal connection with the regulating device, through which at least one measurement value of the at least one injector can be measured by the sensor.

4. The combustion engine in accordance with claim 3, wherein the algorithm possesses a feedback loop which uses a preliminary signal calculated by a preliminary control system for the actuator trigger signal for the injection duration, and the at least one measurement value, calculates a volume of the liquid fuel issued via the exit opening of the injector, using the injector model and, if necessary, corrects the preliminary control signal for the injection duration as calculated by the preliminary control system using a correction value.

5. The combustion engine in accordance with claim 1, wherein the algorithm possesses an observer function which, by using the injector model, the actuator trigger signal, and the at least one measurement value, estimates the injector mass of the liquid fuel.

6. The combustion engine in accordance with claim 1, wherein the injector model contains at least:
pressure progressions in volumes of the injector filled with the liquid fuel;
mass flow rates between the volumes of the injector filled with the liquid fuel;
a position of the needle with relation to a needle seat; and
dynamics of the actuator of the needle.

7. The combustion engine in accordance with claim 1, wherein the injector possesses at least:
one input accumulator chamber connected with one Common-Rail of the combustion engine;
one accumulator chamber for the liquid fuel, connected with the input accumulator chamber;
one volume above the needle seat connected with the accumulator chamber;
one connection volume connected on one side with the accumulator chamber and on an other side with an outflow duct;
one output opening for the liquid fuel that can be closed by the needle and which is connected with a volume above the needle seat;
one actuator that can be triggered by an actuator triggering signal for opening the needle; and
one control chamber joined on one side to the accumulator chamber and on an other side to the connection volume.

8. The combustion engine in accordance with claim 1, wherein at least one measurement value is selected from the following values or a combination thereof:
pressure of one Common-Rail of the combustion engine;
pressure in one input accumulator chamber of the injector;
pressure in one control chamber of the injector; and
commencement of lift-off of the needle from a needle seat.

9. The combustion engine in accordance with claim 1, wherein the regulating device carries out the algorithm during each combustion cycle, or during selected combustion cycles of the combustion engine and corrects the actuator triggering signal during such combustion cycle, in case of deviations.

10. The combustion engine in accordance with claim 1, wherein the regulating device carries out the algorithm during each combustion cycle or during selected combustion cycles of the combustion engine, and in case of deviations, corrects the actuator triggering signal in a subsequent combustion cycle.

11. The combustion engine in accordance with claim 1, wherein the regulating device carries out the algorithm during each combustion cycle or during selected combustion cycles of the combustion engine and statically evaluates any deviations occurring, and carries out a correction of the actuator triggering signal for the current or for a subsequent combustion cycle based on the static evaluation.

12. A process for operation of the combustion engine in accordance with claim 1, comprising: transferring the liquid fuel to a combustion chamber of the combustion engine, calculating the mass of the liquid fuel fed into the combustion chamber through use of the injector model based on the actuator trigger signal for an actuator of the injector for the liquid fuel and in which the actuator trigger signal is corrected in case of deviations between a target value for the mass of the liquid fuel and the calculated mass.

13. A process for operating an injector comprising: injecting liquid fuel into a combustion chamber of a combustion engine; and calculating a mass of the liquid fuel fed into the combustion chamber by the injector using an injector model based on an actuator trigger signal of an actuator of the injector for the liquid fuel, with the actuator trigger signal corrected in case of deviations between a target value for the mass of the liquid fuel and the calculated mass.
